(19) United States
(12) Patent Application Publication
(10) Pub. No.: US 2025/0285804 A1
(43) Pub. Date: Sep. 11, 2025

(54) COIL DEVICE

(71) Applicant: TDK CORPORATION, Tokyo (JP)

(72) Inventors: Riku UMEKI, Tokyo (JP); Kiyofumi FUJIWARA, Tokyo (JP); Satoshi SUGIMOTO, Tokyo (JP)

(73) Assignee: TDK CORPORATION, Tokyo (JP)

(21) Appl. No.: 19/057,583

(22) Filed: Feb. 19, 2025

(30) Foreign Application Priority Data
Mar. 11, 2024 (JP) 2024-037414

(51) Int. Cl. H01F 27/30; H01F 27/24

(52) U.S. Cl. CPC H01F 27/306; H01F 27/24

(57) ABSTRACT

A coil device including: a first conductor having a first main body, a second conductor having a second main body in the first main body and extending along the first main body, and a core in which the first and the second main body are inside of the core; wherein the second main body is inside of the first main body in the core and extends along the first main body, the second conductor includes a second mounting part formed with the second main body, a first mounting part of the first conductor and the second mounting part of the second conductor along a base surface of the core, and a second lead-out part between the second main body and the second mounting part includes a curved part which changes a lead-out direction so that the second mounting part is pulled out to a position different from the first.

### TECHNICAL FIELD

The present disclosure relates to a coil device, for example, used as an inductor or so.

### BACKGROUND

For example, a coil device shown in the below described Patent Document 1 is proposed. A conventional coil device has a risk of causing short circuit since the distance between mounting parts of a coil is short; and as a measure to correspond to this matter, a structure provided with a resin spacer between the coils is proposed.
[Patent Document 1] JP Patent Laid Open No. 2022-33703

### SUMMARY

The object of the present disclosure is to provide a coil device capable of reducing short circuit malfunctions between conductors configuring the coil without using a resin spacer.

In order to achieve the above-mentioned object, the coil device according to one embodiment of the present disclosure includes:
a first conductor having a first main body,
a second conductor having a second main body arranged inside the first main body and at least partially extending along the first main body, and
a core in which the first main body and the second main body are arranged inside of the core;
wherein
the second main body is arranged inside of the first main body in the core and extends along the first main body,
the second conductor includes a second mounting part continuous with the second main body,
a first mounting part of the first conductor and the second mounting part of the second conductor are arranged along a base surface of the core, and
a second lead-out part provided between the second main body and the second mounting part includes a curved part which changes a lead-out direction along the base surface so that the second mounting part is pulled out to a position different from the first mounting part.

In this coil device, the second main body of the second conductor is arranged inside of the first main body of the first conductor in the core, and the second main body and the first main body are stacked (overlying) while taking a predetermined space in between. Thus, efficient transfer of magnetic flux between the first conductor and the second conductor is possible, and magnetic coupling between the first conductor and the second conductor can be enlarged sufficiently.

Also, in this coil device, the second lead-out part has a curved part which changes a lead-out direction along the base surface of the core. Thus, it is possible to prevent short circuits between the end parts of the second conductor and also possible to effectively prevent short circuits between the first conductor and the second conductor without using a resin spacer.

The second lead-out part may be configured of the curved part only; however, the second lead-out part may further have an intermediate part which connects the curved part and the second mounting part in a continuous manner. The intermediate part preferably has a straight-line edge which is continuous with an outline of the curved part; however, the edge may be a curved line, a zigzag-line, or a wavy form line.

Preferably, the second lead-out part includes a pair of second lead-out parts formed at both ends of the second conductor,
each of the pair of the second lead-out parts respectively comprises the straight-line edge,
the straight-line edge of one of the pair of second lead-out parts and the straight-line edge of the other one of the pair of second lead-out parts have a predetermined distance between each other and are arranged parallel to each other, and
the second mounting part includes a pair of second mounting parts and each of the pair of second mounting parts is arranged at a position which is opposite with respect to each other along the base surface of the core.

By configuring as such, an insulation distance between the pair of straight-line edges can be secured easily; hence, even if the area of the base surface is relatively small, the second lead-out parts positioned at the both ends of the second conductor can be easily insulated securely. Also, the mounting parts positioned at the both ends of the second conductor can be easily insulated securely. Furthermore, insulation between the first mounting part and the second mounting part can be secured easily.

The core may include a first core and a second core facing the first core. Preferably, the second mounting part is positioned outside of the first mounting part along a first direction parallel to a facing direction of the first core and the second core on the base surface of the core.

By configuring as such, even if the area of the base surface of the core is relatively small, the second lead-out parts positioned at the both ends of the second conductor can be easily insulated securely. Also, the second mounting parts positioned at the both ends of the second conductor can be easily insulated securely. Further, the first mounting part and the second mounting part can be easily insulated securely.

Preferably, a conductor width of the second mounting part is wider than a conductor width of the second lead-out part. By configuring as such, a bonding area of the second mounting part and a land pattern of a circuit board or so increases and a bonding strength improves. Also, even if positions between the land pattern of the circuit board or so and the second mounting part are shifted, the bonding strength between the land pattern and the second mounting part can be secured easily.

Preferably, the first mounting part includes a pair of first mounting parts formed at both ends of the first conductor. Also, preferably, the second mounting part includes a pair of second mounting parts formed at both ends of the second conductor. A base surface of the core may include at least four outer edges configuring a polygon shape. Preferably, each of the pair of first mounting parts is arranged in a direction facing two of the at least four outer edges facing away from each other, and

each of the pair of second mounting parts is arranged in a direction facing two of the at least four outer edges facing away from each other which are different edges that the first mounting part are facing.

By configuring as such, even if the area of the base surface is relatively small, the second lead-out parts which are positioned at the both ends of the second conductor can be easily insulated securely. Also, the second mounting parts which are positioned at the both ends of the second conductor can be easily insulated securely. Further, the first mounting part and the second mounting part can be easily insulated securely.

Preferably, the first conductor and the second conductor each respectively have a flat wire shape within one turn.

Preferably, a width of the second main body is narrower than a width of the first main body. When such relation is satisfied, the curved part can be easily formed to the second lead-out part; and, even if the area of the base surface is relatively small, the second lead-out parts positioned at both ends of the second conductor can be easily insulated securely. Also, the second mounting parts which are positioned at the both ends of the second conductor can be easily insulated securely. Further, the first mounting part and the second mounting part can be easily insulated securely.

An inner surface of the core may include a step part corresponding to each width of the second main body and the first main body.

Preferably, an insulation layer may be formed on a surface of the first main body. An insulation layer may not be formed on the surface of the second main body.

### BRIEF DESCRIPTION OF DRAWINGS

FIG. 1 is a perspective view of a coil device according to one embodiment of the present disclosure.

FIG. 2A is an explosive perspective view of the coil device shown in FIG. 1.

FIG. 2B is an explosive perspective view of the coil device shown in FIG. 1, and an observation angle is different from FIG. 2A.

FIG. 3A is a bottom view of the coil device shown in FIG. 1.

FIG. 3B is a bottom view of a coil device according to further another embodiment.

FIG. 3C is a bottom view of a coil device according to further another embodiment.

FIG. 3D is a bottom view of a coil device according to further another embodiment.

FIG. 4 is a bottom view of the coil device shown in FIG. 1.

FIG. 5 is a perspective view of the base surface showing an arrangement method according to one example of the coil device shown in FIG. 1.

### DESCRIPTION

In below, embodiments of the present disclosure are described.

### First Embodiment

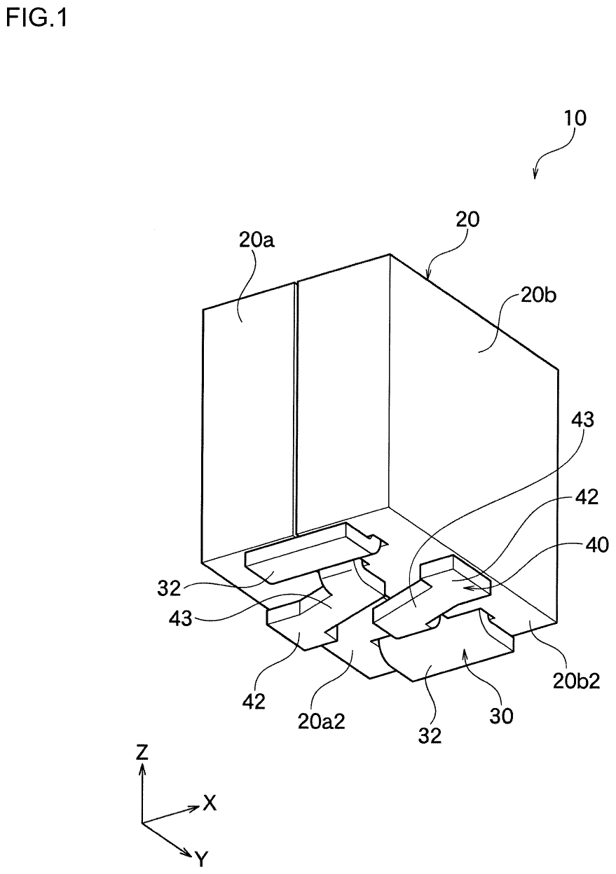

As shown in FIG. 1, a coil device 10 according to the present embodiment is approximately a rectangular parallelepiped shape; and, it functions as a coupling coil used for a power circuit or so. An X-axis direction width of the coil device 10 is preferably 3.0 to 12.0 mm, and a Y-axis direction width is preferably 3.0 to 6.0 mm, and a Z-axis direction width is preferably 3.0 to 12.0 mm. Note that, the X-axis, the Y-axis, and the Z-axis are approximately perpendicular to each other. In the present embodiment, the Z-axis is a height direction of the coil device 10. Also, in the below description, an inner side is a direction towards the center of a member (for example, the center of the coil device 10) along each axis, and an outer side is a direction away from the center.

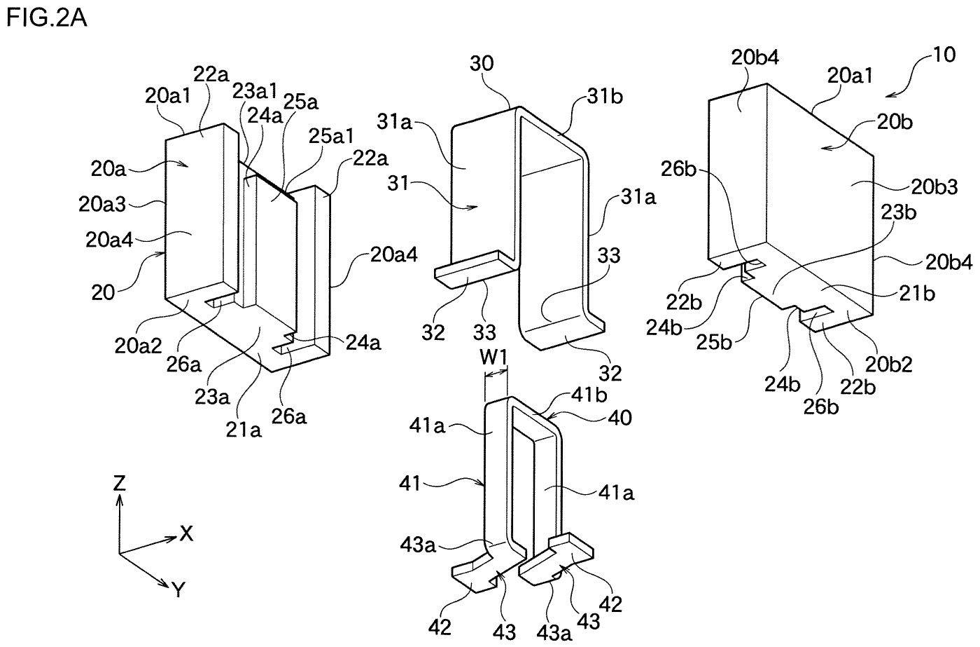

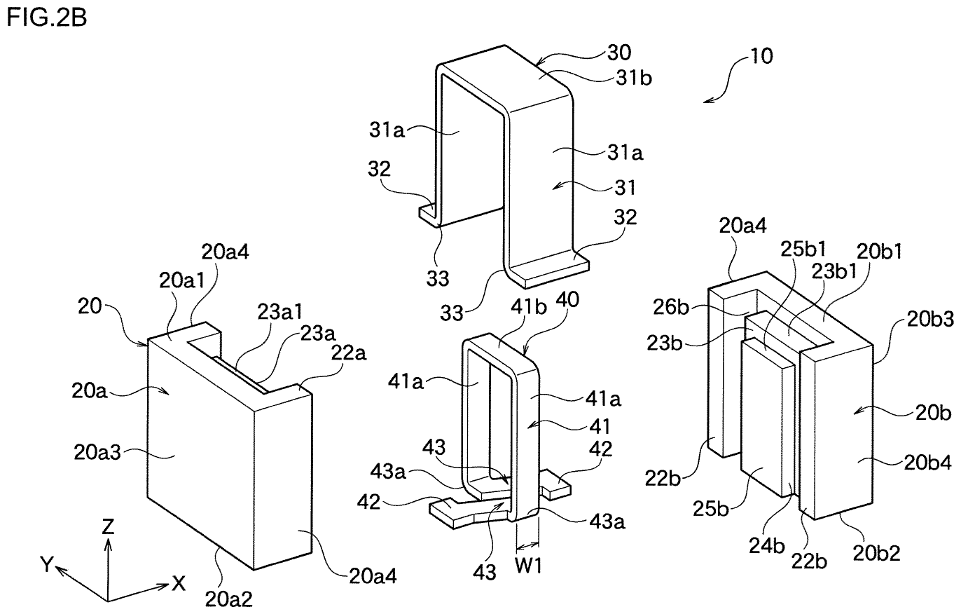

As shown in FIG. 2A and FIG. 2B, the coil device 10 includes a core 20 configured of a first core 20a and a second core 20b, a first conductor 30, and a second conductor 40. Either one of the first conductor 30 and the second conductor 40 functions as a primary coil, and the other one functions as a secondary coil. Details of the conductors 30 and 40 are described later.

The first core 20a and the second core 20b respectively has a configuration of a so-called E-type core; and preferably these have the same shapes; however, the shapes do not necessarily have to be the exact same. For example, a length of an outer leg part 22a and 22b of the core 20a and 20b, which are described later, along the X-axis may be different and a length of a middle leg part 23a and 23b along the X-axis may be different. Also, the length of the either one of the outer leg part 22a or the outer leg part 22b may be made longer, and a length of the other one of the outer leg part 22a or the outer leg part 22b may be zero.

In the present embodiment, each core 20a and 20b respectively has the same configuration as described in below.

The first core 20a includes a first base part 21a having an outer side surface 20a3 extending along the Y-axis and the Z-axis, and a pair of outer leg parts 22a and 22a which protrude inward along the X-axis from the both ends along the Y-axis of the first base part 21a. When the core 20a and the core 20b are combined, the outer side surfaces 20a4 and 20a4 of each outer leg part 22a and 22a are positioned roughly on the same plane as the outer side surface 20b4 of the second core 20b which are described later. Here, “roughly on the same plane” means that a production error, or ±0.2 mm or so of shifting is permissible. The same applies hereinafter.

Also, at the inside of the first base part 21a which is positioned at the center in the Y-axis direction of the pair of outer leg parts 22a and 22a, a middle leg part 23a is integrally formed which protrudes inwards from the base part 21a. At a tip side along the X-axis direction of the middle leg part 23a, a step-like depressed part 24a is respectively formed at the both ends along the Y-axis; and, a first raised part 25a is formed between the step-like depressed parts 24a. The first raised part 25a is a part which enters inside the second main body 41 of the second conductor 40.

The first step-like depressed part 24a engages with one of the side edges of a leg part 41a extending along the Z-axis of the second main body 41. Also, a connecting part 41b integrally connects an upper end in the Z-axis direction of a pair of leg parts 41a of the second main body 41; and the connecting part 41b is disposed on an upper end face 25a1 of the raised part 25a of the core 20a.

A first groove 26a is formed between the first middle leg part 23a and the first outer leg part 22a of the first core 20a. One of side edges of a leg part 31a extending along the Z-axis of the first main body 31 of the first conductor 30 is inserted into and engages with the first groove 26a. Also, a connecting part 31b integrally connects upper ends in the Z-axis of a pair of leg parts 31a of the first main body 31; and the connecting part 31b is disposed on an upper end surface 23a1 of the middle leg part 23a of the core 20a.

The upper end surface 23a1 of the middle leg part 23a is one step lower along the Z-axis than the outer leg part 22a of the core 20a and the upper end surface 20a1 of the base part 21a. The upper end surface 25a1 of the raised part 25a is one step lower along the Z-axis than the upper end surface 23al of the middle leg part 23a. A height difference along the Z-axis between the upper end surface 23a1 of the middle leg part 23a and the upper end surface 20a1 of the core 20a is preferably about the same as the thickness of the connecting part 31b of the first conductor 30, and also preferably the upper surface of the connecting part 31b and the upper end surface 20al are positioned on about the same plane. Also, a height difference along the Z-axis between the upper end surface 25a1 of the raised part 25a and the upper end surface 23a1 of the middle leg part 23a is preferably about the same or thicker than the thickness of the connecting part 41b of the second conductor 40.

The second core 20b has a second base part 21b including an outer side surface 20b3 which extends along the Y-axis and the Z-axis, and the pair of outer leg parts 22b and 22b which protrudes inward along the X-axis from both ends along the Y-axis of the second base part 21b. When the core 20a and the core 20b are combined, the outer side surfaces 20b4 and 20b4 of the outer leg part 22b are positioned on about the same plane as the outer side surfaces 20a4 and 20a4 of the aforementioned first core 20a.

Also, at the inner surface of the second base part 21b positioned at the center part in the Y-axis of the pair of outer leg parts 22b and 22b, a middle leg part 23b is integrally formed which protrudes inward from the base part 21b. At a tip side along the X-axis direction of the middle leg part 23b, a step-like depressed part 24b is respectively formed at the both ends along the Y-axis; and, a second raised part 25b is formed between the step-like depressed parts 24b and 24b. The second raised part 25b is a part which protrudes along the X-axis and enters inside the second main body 41 of the second conductor 40.

The second step-like depressed part 24b engages with the other one of the side edges of leg part 41a extending along the Z-axis of the second main body 41. Also, the connecting part 41b integrally connects an upper end of a pair of leg parts 41a in the Z-axis direction of the second main body 41; and the connecting part 41b is disposed over an upper end face 25b1 of the raised part 25b of the core 20b.

A second groove 26b is formed between the second middle leg part 23b and the second outer leg part 22b of the second core 20b. The other one of the side edges of the leg part 31a extending along the Z-axis of the first main body 31 of the first conductor 30 is inserted into and engages with the second groove 26b. Also, the connecting part 31b integrally connects upper ends of a pair of the leg parts 31a in the Z-axis of the first main body 31; and the connecting part 31b is disposed over an upper end surface 23b1 of the middle leg part 23b of the core 20b.

As shown in FIG. 2B, the upper end surface 23b1 of the middle leg part 23b is one step lower along the Z-axis than the outer leg part 22b of the core 20b and the upper end surface 20b1 of the base part 21b. The upper end surface 25b1 of the raised part 25b is one step lower along the Z-axis than the upper end surface 23b1 of the middle leg part 23b. A height difference along the Z-axis between the upper end surface 23b1 of the middle leg part 23b and the upper end surface 20b1 of the core 20b is preferably about the same as the thickness of the connecting part 31b of the first conductor 30, and also preferably the upper surface of the connecting part 31b and the upper end surface 20b1 are positioned on about the same plane. Also, a height difference along the Z-axis between the upper end surface 25b1 of the raised part 25b and the upper end surface 23b1 of the middle leg part 23b is preferably about the same or thicker than the thickness of the connecting part 41b of the second conductor 40.

The tip surface along the X-axis of the outer leg part 22a of the first core 20a and the tip surface along the X-axis of the outer leg part 22b of the second core 20b preferably face against each other and bonded using an adhesive or so. The tip surface along the X-axis of the middle leg part 23a of the first core 20a (specifically, the tip surface of the raised part 25a) and the tip surface along the X-axis of the middle leg part 23b of the second core 20b (specifically, the tip surface of the raised part 25b) may face against each other and adhered, or there may be a predetermined gap in between.

The first core 20a and the second core 20b are each configured of a magnetic material, and for example, it may be a magnetic material with a relatively high permeability. Examples of such magnetic material include ferrite such as Ni—Zn-based ferrite, and Mn—Zn-based ferrite; and a metal magnetic material. Also, the first core 20a and the second core 20b may be each configured of a sintered body, or it may be formed by molding a resin including a magnetic powder.

The first conductor 30 is configured of a conductor plate of a flat plate shape (such as a flat wire), and the first conductor 30 includes the first main body 31 which is approximately a U-shape. The first conductor 30 is arranged, together with the second conductor 40, between the first core 20a and the second core 20b. Examples of the material configuring the first conductor 30 include good conductors such as copper and copper alloy, silver, nickel, etc.; and as long as the material is a conductive material, it is not particularly limited. For example, the first conductor 30 is formed by mechanically processing a metal plate, and a method for forming the first conductor 30 is not limited to this.

In the example shown in the figure, the first conductor 30 has an elongated shape as a whole, and a height along the Z-axis of the first conductor 30 is larger than widths in the X-axis direction and the Y-axis direction. The cross-section area perpendicular to an extending direction of the first conductor 30 is preferably about the same as the cross-section area perpendicular to an extending direction of the second conductor 40. The thickness (the plate thickness) of the first conductor 30 is thinner by about 1/n than the thickness (the plate thickness) of the second conductor 40, and a width along the X-axis of the first conductor 30 is preferably wider by about n times than a width along the X-axis direction of the second conductor 40. Note that, n is preferably any number of 2 or larger. The thickness of the first conductor 30 is preferably 0.3 to 2.0 mm.

A plating layer may be formed on the entire surface of the first conductor 30. The plating layer may be a single layer or a plurality of layers; and for example, the plating layer may be configured of Cu plating, Ni plating, Sn plating, Ni—Sn plating, Cu—Ni—Sn plating, Ni—Au plating, Au plating, etc. The plating layer is formed on the surface of the first conductor 30 by carrying out an electroplating or electroless plating. A thickness of the plating layer is not particularly limited, and preferably it is 1 to 30 μm.

The first conductor 30 has a first main body 31 and first mounting parts 32 and 32 which are respectively formed integrally at both ends of the first main body 31. The first main body 31 has a pair of leg parts 31a extending in the Z-axis direction while taking a predetermined distance along the Y-axis direction, and the first main body 31 also has the connecting part 31b which integrally connects the upper ends of the leg parts 31a. The first main body 31 is a coil formed approximately in a U-like shape of less than 1 turn.

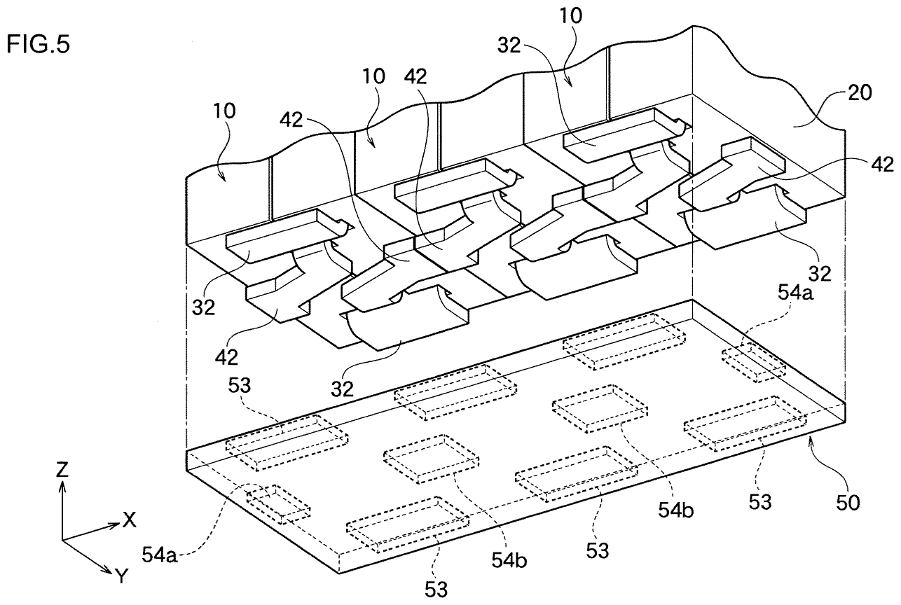

A lead-out part 33 is formed with a plate surface curved part which the angle of the plate surface of the conductor 30 bends approximately perpendicularly, and the plate surface curved part is provided between the mounting part 32 and lower ends of each of the leg parts 31a of the first main body 31. Either one of the pair of mounting parts 32 functions as an input terminal (or an output terminal) and the other one functions as an output terminal (or an input terminal). The mounting parts 32 and 32 extend outward along the Y-axis. For example, the mounting parts 32 and 32 connect to a first land electrode 53 formed on the mounting surface of the base board 50 for mounting as shown in FIG. 5 via a bonding member such as a solder, a conductive adhesive agent, etc.

As shown in FIG. 1, the mounting parts 32 and 32 are exposed to the outside from the base surfaces 20a2 and 20b2 of the core 20. Also, the insulation coating which coats the first conductor 30 is removed from at least the lower surface of the mounting parts 32 and 32, and the first land electrode 53 shown in FIG. 5 or so and the first conductor 30 can be connected electrically.

As shown in FIG. 2A and FIG. 2B, the second conductor 40 is formed, for example, by press processing a metal plate; and, the second conductor 40 includes the second main body 41 which is approximately a U-shape, the lead-out parts 43 formed at the both ends of the second main body 41, and the mounting part 42 formed at the tip of the lead-out part 43. The second conductor 40 can be configured of the same material as the first conductor 30; however, the second conductor 40 has the lead-out part 43 of a complex configuration, unlike the lead-out part 33 of the first conductor 30; thus, the insulation coating may not be formed to the second conductor 40.

The second conductor 40 is arranged inside of the cores 20a and 20b as similar to the first conductor 30 (the second conductor 40 is arranged in the groove parts 26a and 26b, and the step-like depressed parts 24a and 24b). The leg part 31a of the first conductor 30 is inserted in the groove parts 26a and 26b, and the leg parts 41a and 41a of the second conductor 40 engage with step-like depressed parts 24a and 24b. By arranging as such, the second main body 41 of the second conductor 40 is arranged inside the first main body 31 of the first conductor 30 by taking a predetermined space. Note that, in the case that the surface of the first main body of the first conductor 30 is insulation coated, the second main body 41 may contact to at least part of the inner side of the first main body 31.

In the example shown in the figures, the second conductor 40 has an elongated shape, and a height in the Z-axis direction of the second conductor 40 is longer than the length in the Y-axis direction of the second conductor 40. The second main body 41 of the second conductor 40 is smaller than the first main body 31 of the first conductor 30, and when these are arranged, the second main body 41 is surrounded by the first main body 31. The width along the X-axis of the second main body 41 is narrower than the width along the X-axis of the first main body 31; and the second main body 41 is preferably arranged roughly at the center position along the X-axis of the first main body 31; however, the position may be shifted slightly.

The second conductor 40 has the pair of mounting parts 42 formed at the both ends of a belt-like metal plate configuring the second main body 41. The second main body 41 has a pair of leg parts 41a extending along the Z-axis direction while taking a predetermined distance along the Y-axis between the leg parts 41a, and the connecting part 41b integrally connecting the upper ends of the leg parts 41a. Further, the second main body 41 configures a coil of approximately a U-shape of less than 1 turn.

The lead-out part 43 is formed between the mounting part 42 and the lower end of the leg part 41a of the second main body 41. Either one of the pair of mounting parts 42 functions as an input terminal (or an output terminal), and the other one functions as an output terminal (or input terminal). The lead-out direction of the mounting parts 42 and 42 is changed by the lead-out parts 43, and the mounting parts respectively extends along the X-axis.

These mounting parts 42 and 42 connect to a second land electrode 54a or a common second land electrode 54b, for example, formed on the mounting surface of the base board 50 for mounting as shown in FIG. 5 via a bonding member such as a solder, a conductive adhesive agent, etc.

As shown in FIG. 1, the lead-out parts 43 and the mounting parts 42 and 42 are exposed to the outside from the base surfaces 20a2 and 20b2 of the core 20. Also, in the case that the second conductor 40 is insulation coated, the insulation coating is removed from the lower surfaces of the mounting parts 42 and 42, and the second conductor 40 can be electrically connected to the second land electrode 54a or a common second land electrode 54b shown in FIG. 5.

As shown in FIG. 2A and FIG. 2B, the pair of lead-out parts 43 of the second conductor 40 respectively has a first curved part 43a corresponding to the lead-out part 33 of the first conductor 30. The first curved part 43a is configured of a plate surface curved part where an angle of the plate surface is bent approximately perpendicularly. Unlike the first lead-out part 33 which is bent outward, the plate surface of the lead-out part 43 is bent inward. Due to the first curved part 43a, the lead-out direction of the lead-out part 43 changes to inward direction along the Y-axis from the lower end of second leg part 41a shown in FIG. 2A.

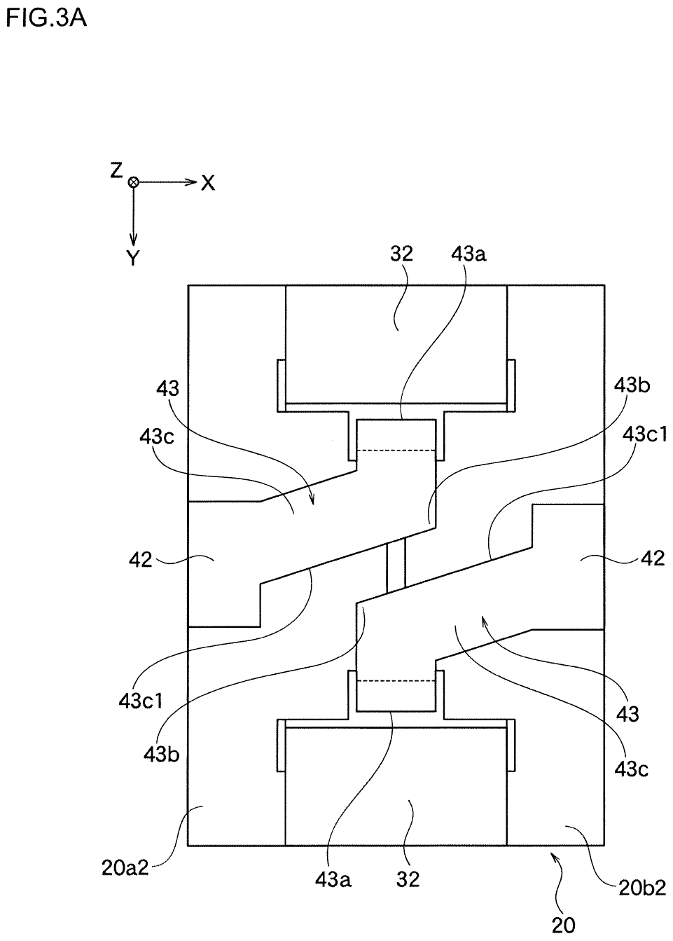

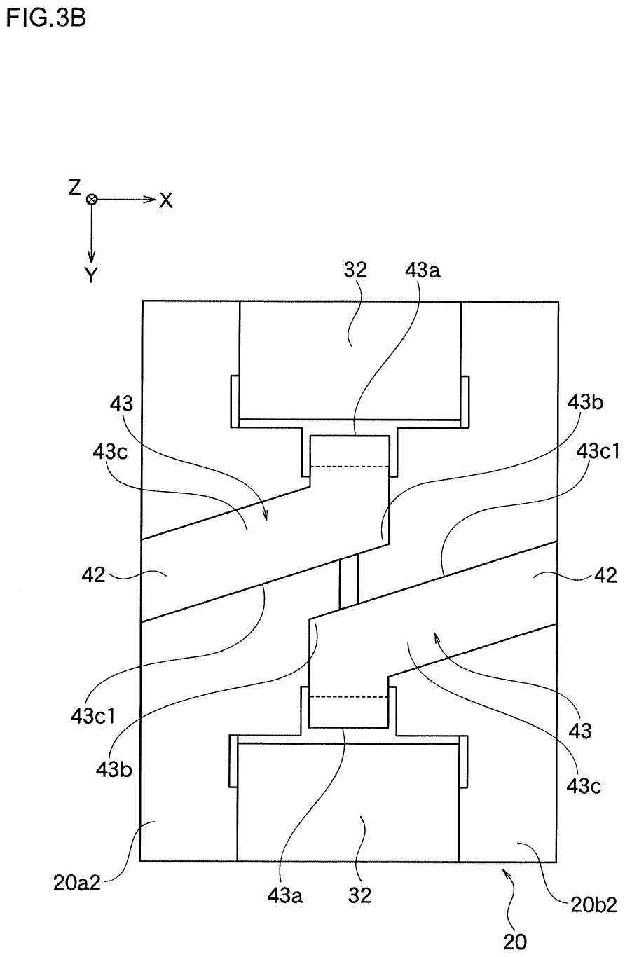

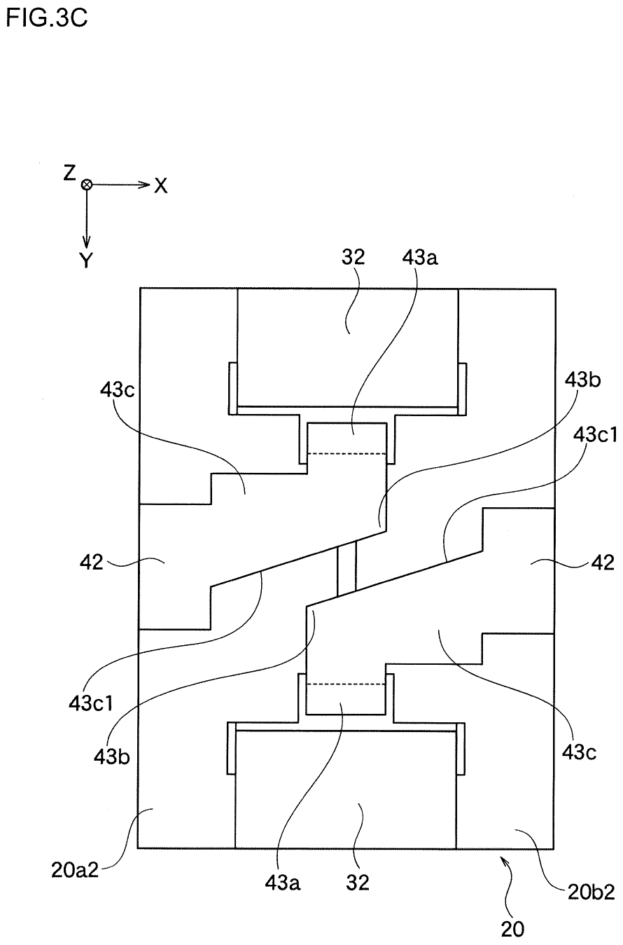

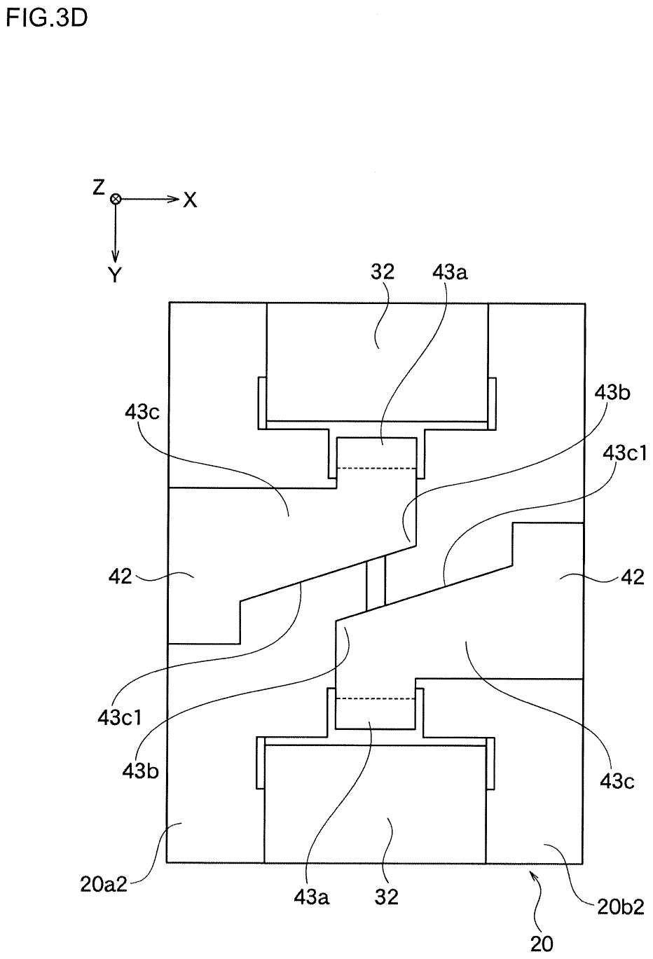

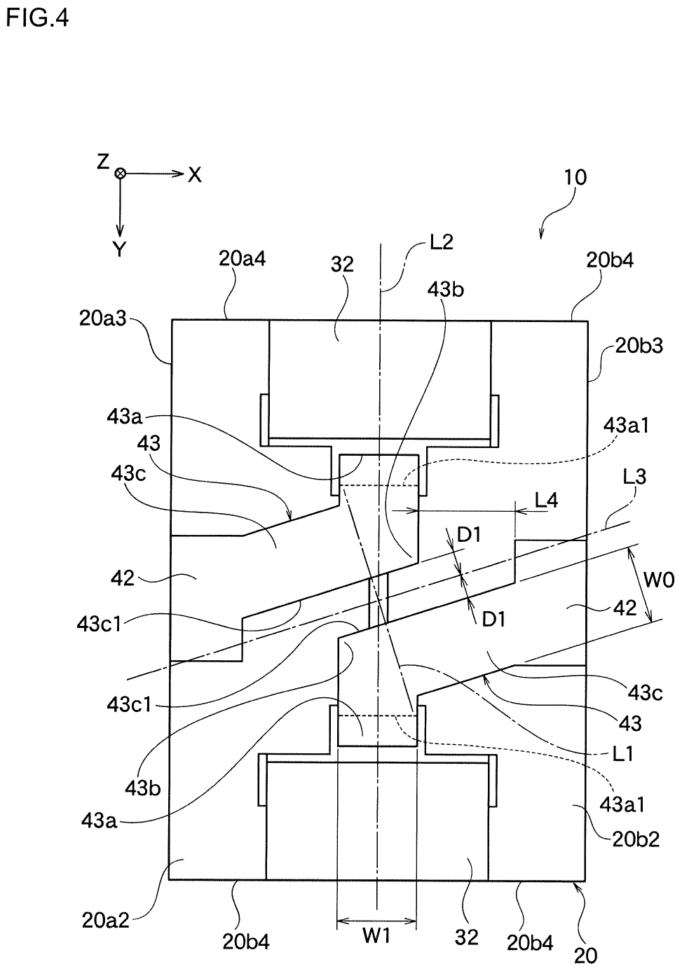

As shown in FIG. 3A and FIG. 4, each of the pair of lead-out parts 43 of the second conductor 40 incudes the second curved part 43b and the intermediate part 43c in addition to the first curved part 43a. The second curved part 43b is continuous with the first curved part 43a. The lead-out direction of the lead-out part 43 which has been changed by the first curved part is further changed by the second curved part 43b in a predetermined angle such as an obtuse angle (the angle may be a perpendicular angle or an acute angle) along the base surfaces 20a2 and 20b2 of the core 20. Note that, unlike the first curved part 43a, the second curved part 43b does not change the angle of the plate surface but rather changes the lead-out direction in parallel along the plate surface.

As shown in FIG. 4, the lead-out direction of one of the lead-out parts 43, which the lead-out direction has been changed inward along the Y-axis, is changed by one of the pair of second curved parts 43b in a predetermined angle such as an obtuse angle (the angle may be a perpendicular angle or an acute angle) towards an outer side surface 20a3 of the core 20. Also, the lead-out direction of the other one of the lead-out parts 43, which the lead-out direction has been changed inward along the Y-axis, is changed by the other one of the pair of second curved parts 43b in a predetermined angle such as an obtuse angle (the angle may be a perpendicular angle or an acute angle) towards an outer side surface 20b3 of the core 20.

In the present embodiment, the outer edge of the second curved part 43b is an angular edge when observed from a direction parallel to the Z-axis; however, it is not limited to this and the outer edge may be curved. The intermediate part 43c is positioned between the second curved part 43b and the second mounting part 42, and the intermediate part 43c has a straight-line edge 43c1 which is continuous with the outline of the second curved part 43b.

The straight-line edges 43c1 of the pair of intermediate parts 43c are parallel to each other and spaced apart by a predetermined distance (2×D1) along the base surfaces 20a2 and 20b2 of the core 20; and the straight-line edges 43c1 respectively extends diagonally toward the side surfaces 20a3 and 20b3 positioned opposite to each other. The mounting parts 42 and 42 are integrally formed to the tip of each intermediate part 43c.

Regarding one of the pair of mounting parts 42 and 42, the end edge along the X-axis is positioned at approximately the same plane as the outer side surface 20a3 of the core 20, and the end edge preferably is positioned approximately at the center of the outer side surface 20a3 along the Y-axis. Also, regarding the other one of the pair of mounting parts 42 and 42, the end edge along the X-axis is positioned at approximately the same plane as the outer side surface 20b3 of the core 20, and the end edge is preferably positioned approximately at the center of the outer side surface 20b3 along the Y-axis.

In the present embodiment, a width W0 which is perpendicular to the diagonal lead-out direction of the intermediate part 43c is preferably uniform along the diagonal lead-out direction, and for example, the width W0 is preferably about the same as a width W1 along the X-axis of the leg part 41a and the connecting part 41b shown in FIG. 2A. The cross-section area of the leg part 41a and the cross-section area of the intermediate part 43c which are perpendicular to the direction of current flow of the second conductor 40 are roughly the same. Further, the cross-section area of the connecting part 41b and the cross-section area of the intermediate part 43c which are perpendicular to the direction current flow of the second conductor 40 are roughly the same. Thereby, uniform electric resistance can be achieved.

The width along the Y-axis of the mount part 42 is preferably wider than the width perpendicular to the diagonal lead-out direction of the intermediate part 43c. This is because, as shown in FIG. 5, the mounting parts 42 connect with the land electrodes 54a and 54b of the base board 50; thus, such configuration is preferable from the point of achieving a good electrical connection between the mounting parts 42 and the land electrodes 54a and 54b, and also achieving enhanced connection strength.

The angle of the straight-line edge 43c1 of the lead-out part 43 with respect to the Y-axis (that is, the bent angle of the second curved part 43b) is determined for example as described in below.

As shown in FIG. 4, one end along the X-axis of one of inward bending start lines 43a1 of the pair of first curved parts 43a and 43a and the other end along the X-axis of the other one of the inward bending start lines 43a1 of the pair of first curved parts 43a and 43a are connected using a hypothetical line. Also, a center line which divides a total area of the base surfaces 20a2 and 20b2 of the core 20 into half along a hypothetical line parallel to the Y-axis is defined as a center line L2.

A line crossing the intersection between the center line L2 and the hypothetical line L1 and being perpendicular to the hypothetical line L1 is defined as a hypothetical line L3. The angle of the hypothetical line L3 with respect to the Y-axis is a curved angle of the second curved part 43b. The straight-line edge 43c1 positioned at the inside of each of the pair of intermediate parts 43c is set to be parallel to the hypothetical line 13. A distance D1, which is between the hypothetical line L3 and the straight-line edge 43c1, is preferably 0.2 mm or larger, further preferably 0.3 mm or larger, or even more preferably 0.5 mm or larger. Also, a distance L4 between the curved parts 43a and 43b and the second mounting part 42 which is in close proximity with the curved parts 43a and 43b is not particularly limited, and preferably it is 0.5 mm or larger, more preferably 0.8 mm or larger, or further preferably 1.0 mm or larger.

In the present embodiment, the outer side surface 20a3 and the outer side surface 20b3 are positioned facing away from each other along the X-axis of the core 20. Also, the outer side surface 20a4 and the outer side surface 20a4 are positioned facing away from each other along the Y-axis of the core 20, and the outer side surface 20b4 and the outer side surface 20b4 are positioned facing away from each other along the Y-axis of the core 20.

In the present embodiment, one of the first mounting parts 32 is arranged so that the outer end edge of the first mounting part 32 roughly matches the position corresponding to the plane of one of the outer side surfaces 20a4 and 20b4, and the other one of the first mounting parts 32 is arranged so that the outer end edge of the first mounting part 32 roughly matches the position corresponding to the plane of one of the outer side surfaces 20a4 and 20b4. Note that, as similar to “roughly on the same plane”, “roughly matches” means that a production error, or ±0.2 mm or so of shifting is allowed.

That is, in the present embodiment, the four mounting parts 32, 32, 42, and 42 are arranged along the base surfaces 20a2 and 20b2 of the core 20 so that the outer end edges of the four mounting parts roughly match to the respective side surface of the four side surfaces of the core 20. The main body of the mounting part may be in contact with or not in contact with the base surface of the core, and preferably it is in contact.

In the coil device 10 according to the present embodiment, the second main body 41 of the second conductor 40 is arranged inside the first main body 31 of the first conductor 30 at the inside of the core 20. The first main body 31 is stacked (overlies) on the second main body 41 by taking a predetermined distance (space or by having the insulation coating) between each other. Therefore, magnetic flux can be transferred efficiently between the first conductor 30 and the second conductor 40, and magnetic coupling between the first conductor 30 and the second conductor 40 can be made sufficiently stronger.

Also, in this coil device 10, each of the pair of second lead-out parts 43 has the second curved part 43b which changes the lead-out direction along the base surfaces 20a2 and 20b2 of the core 20. Thus, short circuit between the terminals of the second conductor 40 or short circuit between the first conductor 30 and the second conductor 40 can be secured effectively without using a resin spacer.

Each of the pair of second lead-out parts 43 may be configured only from the first curved part 43a and the second curved part 43b. However, in the present embodiment, the second lead-out part 43 further includes the intermediate part 43c which connects the second curved part 43b and the second mounting part 42 in a continuous manner. Each of the pair of intermediate parts 43c includes the straight-line edge 43c1 which is continuous with the outline of the second curved part; and the straight-line edge 43c1 of one of the pair of second lead-out parts 43 and the straight-line edge 43c1 of the other one of the pair of second lead-out parts 43 have a predetermined distance (2×D1) between each other and are arranged parallel to each other. Further, the second mounting parts 42 and 42 are arranged along the base surfaces 20a2 and 20b2 of the core 20 and are arranged on opposite sides with respect to each other along the X-axis.

By configuring as such, the insulation distance between the pair of straight-line edges 43c1 can be secured easily, and even in the case that the area of the base surface of the core 20 is relatively small, the second lead-out parts 43 positioned at the both ends of the second conductor 43 can be easily insulated securely. Also, the second mounting parts 42 positioned at the both ends of the second conductor 40 can be easily insulated securely. Further, the first mounting part 32 and the second mounting part 42 can be easily insulated securely.

In the present embodiment, the core 20 includes the first core 20a and the second core 20b facing the first core 20a. The second mounting parts 42 and 42 are positioned along the base surfaces 20a2 and 20b2 of the core 20 and arranged outside of the first mounting parts 32 and 32 along the X-axis parallel to the direction which the first core 20a and the second core 20b are facing.

By configuring as such, even in the case that the area of the base surfaces 20a2 and 20b2 of the core 20 are relatively small, the second lead-out parts 43 positioned at the both ends of the second conductor 40 can be easily insulated securely. Also, the second mounting parts 42 and 42 positioned at both ends of the second conductor 40 can be easily insulated securely. Further, the first mounting part 32 and the second mounting part 42 can be easily insulated securely.

In the present embodiment, a conductor width of the second mounting part 42 along the Y-axis is wider than the conductor width W0 of the second lead-out part 43. By configuring as such, bonding areas between the second mounting parts 42 and the land electrodes 54a and 54b of the base board 50 shown in FIG. 5 can be increased; hence, the bonding strength improves. Also, even in the case that the position shifting occurs between the second mounting parts 42 and the land electrodes 54a and 54b of the base board 50, bonding strength between the land electrodes 54a and 54b and the second mounting parts 42 can be secured easily.

In the present embodiment, the width W1 of the second main body 41 along the X-axis is narrower than the width of the first main body 31. When such relationship is satisfied, the second curved part 43b and the intermediate part 43c can be easily formed to the second lead-out part 43, and even in the case that the area of the base surface of the core is relatively small, the second lead-out parts 43 positioned at the both ends of the second conductor 40 can be easily insulated securely. Also, the second mounting parts 42 positioned at the both ends of the second conductor 40 can be easily insulated securely. Further, insulation between the first mounting part 32 and the second mounting part 42 can be secured easily.

Also, in the present embodiment, as shown in FIG. 5, a plurality of coil devices 10 can be easily aligned in one line (or it may be in a plurality of lines) along the X-axis, and the mounting parts 42 of the coil devices 10 adjacent to each other can be aligned along the X-axis in a close proximity. Therefore, due to the common second land electrodes 54b formed on the mounting surface of the circuit board 50, it is possible to easily form a circuit having the second conductors 40 connected in series in which the second conductors 40 shown in FIG. 2A and FIG. 2B are arranged inside the plurality of coil devices 10 along the X-axis connected as shown in FIG. 5. Also, a circuit with simple configuration can be achieved.

Also, unlike as shown in FIG. 5, one coil device 10 can connect to the land electrodes 53, 54a, and 54b of the base board 50 using a solder or so. For example, in such case, when viewing from the upper side along the Z-axis of the device 10, the bonding material which is raised can be easily observed, such as a solder fillet between the outer end edge of each of the mounting parts 32 and 42 and the land electrodes 53, 54a, and 54b can be observed easily. By observing the bonding material such as a solder fillet which is raised, it becomes easy to determine the condition of bonding.

Note that, as shown in FIG. 5, even in the case of connecting the plurality of coil devices 10 to the base board 50 along the X-axis, the solder fillet of the mounting part 42 positioned at the both ends along the X-axis and the solder fillet of the mounting part 32 of each coil device can be easily observed from the upper side along the Z-axis of the coil device 10.

### Second Embodiment

As shown in FIG. 3B to FIG. 3D, the coil device according to the second embodiment has basically the same configuration as the first embodiment, except that the coil device according to the second embodiment has configurations that shapes of the second lead-out part 43 and/or the second mounting part 42 of the second conductor 40 are different from those of the first embodiment. The configurations of the second embodiment which are the same as the first embodiment exhibit the same effects. In the FIG. 3B to FIG. 3D, the parts which are different from the first embodiment are only shown, and the explanation of the same configurations are omitted.

In the embodiment shown in FIG. 3B, each mounting part 42 is configured as an extension part of the intermediate part 43c, and a width along the Y-axis of the mounting part 42 of the embodiment shown in FIG. 3B is narrower than the width along the Y-axis of the mounting part 42 shown in FIG. 3A. In the embodiment shown in FIG. 3C, a width along the Y-axis of the intermediate part 43c is configured to gradually become wider towards each mounting part 42. In the embodiment shown in FIG. 3D, a width along the Y-axis of the intermediate part 43c is configured to gradually become wider towards each mounting part 42, and also the width along the Y-axis of the mounting part 42 of the embodiment shown in FIG. 3D is wider than the width along the Y-axis of the mounting part 42 shown in FIG. 3A.

Note that, the present disclosure is not limited to the above-mentioned embodiments, and various modifications are possible within the scope of the present disclosure.

For example, in the above-mentioned embodiments, the base surfaces 20a2 and 20b2 of the core 20 are roughly a square shape; however, it may be any other polygon shape, or the base surface of the core may have at least four outer edges which configure a polygon shape. Each of the pair of first mounting parts 32 and 32 are respectively arranged facing the two outer edges which are facing away from each other among the four outer edges, and each of the pair of second mounting parts 42 may be arranged facing the outer edges facing away from each other which are different from those of the first mounting parts 32 and 32 are facing.

By configuring as such, as similar to the aforementioned embodiments, the second lead-out parts 43 positioned at the both ends of the second conductor 40 can be easily insulated securely. Also, the second mounting parts 42 positioned at the both ends of the second conductor 40 can be easily insulated securely. Further, insulation between the first mounting part 32 and the second mounting part 42 can be secured easily.

Also, the aforementioned embodiments are configured so that the pair of intermediate parts 43 respectively has the straight-line edge 43c1. The part where the straight-line edge 43c1 is formed may be a curved-line edge, a zigzag-line edge, a wavy edge, etc. Note that, the pair of intermediate parts is preferably shaped so that the distance between the edges which are facing to each other of the pair of intermediate parts 43c maintains the insulation distance (2×D1).

### REFERENCE SIGNS LISTS

10 . . . Coil device
20 . . . Core
20a . . . First core
20a1 . . . Upper end surface
20a2 . . . Base surface
20a3 . . . Outer side surface
20a4 . . . Outer side surface
20b . . . Second core
20b1 . . . Upper end surface
20b2 . . . Base surface
20b3 . . . Outer side surface
20b4 . . . Outer side surface
21a . . . First base part
21b . . . Second base part
22a . . . First outer leg part
22b . . . Second outer leg part
23a . . . First middle leg part
23a1 . . . Upper end surface
23b . . . Second middle leg part
24a . . . First step-like depressed part
24b . . . Second step-like depressed part
25a . . . First raised part
25a1 . . . Upper end face
25b . . . Second raised part
25b1 . . . Upper end surface
26a . . . First groove
26b . . . Second groove
30 . . . First conductor
31 . . . First main body
31a . . . Leg part
31b . . . Connecting part
32 . . . First mounting part
33 . . . Lead-out part
40 . . . Second conductor
41 . . . Second main body
41a . . . Leg part
41b . . . Connecting part
42 . . . Second mounting part
43 . . . Lead-out part
43a . . . First curved part
43a1 . . . Inward bending beginning line
43b . . . Second curved part
43c . . . Intermediate part
43c1 . . . Straight-line edge
50 . . . Base board
53 . . . First land electrode
54a . . . Second land electrode
54b . . . Common second land electrode

What is claimed is:

1. A coil device comprising:
a first conductor having a first main body,
a second conductor having a second main body arranged inside the first main body and at least partially extending along the first main body, and
a core in which the first main body and the second main body are arranged inside of the core;
wherein
the second main body is arranged inside of the first main body in the core and extends along the first main body,
the second conductor comprises a second mounting part continuous with the second main body,
a first mounting part of the first conductor and the second mounting part of the second conductor are arranged along a base surface of the core, and
a second lead-out part provided between the second main body and the second mounting part comprises a curved part which changes a lead-out direction along the base surface so that the second mounting part is pulled out to a position different from the first mounting part.

2. The coil device according to claim 1, wherein the second lead-out part further comprises an intermediate part connecting the curved part and the second mounting part in a continuous manner, and
the intermediate part comprises a straight-line edge which is continuous with an outline of the curved part.

3. The coil device according to claim 2, wherein the second lead-out part comprises a pair of second lead-out parts formed at both ends of the second conductor,
each of the pair of the second lead-out parts respectively comprises the straight-line edge,
the straight-line edge of one of the pair of second lead-out parts and the straight-line edge of the other one of the pair of second lead-out parts have a predetermined distance between each other and are arranged parallel to each other, and
the second mounting part comprises a pair of second mounting parts and each of the pair of second mounting parts is arranged at a position which is opposite with respect to each other along the base surface of the core.

4. The coil device according to claim 1, wherein the core comprises a first core and a second core facing the first core;
the second mounting part is positioned outside of the first mounting part along a first axis parallel to a direction which the first core and the second core are facing each other along a base surface of the core.

5. The coil device according to claim 1, wherein a conductor width of the second mounting part is wider than a conductor width of the second lead-out part.

6. The coil device according to claim 1, wherein the first mounting part comprises a pair of first mounting parts formed at both ends of the first conductor, the second mounting part comprises a pair of second mounting parts formed at both ends of the second conductor,
a base surface of the core comprises at least four outer edges configuring a polygon shape,
each of the pair of first mounting parts is arranged in a direction facing two of the at least four outer edges facing away from each other, and
each of the pair of second mounting parts is arranged in a direction facing two of the at least four outer edges facing away from each other which are different edges that the first mounting part are facing.

7. The coil device according to claim 1, wherein the first conductor and the second conductor respectively has a flat wire shape within one turn.

8. The coil device according to claim 1, wherein a width of the second main body is narrower than a width of the first main body.

9. The coil device according to claim 8, wherein an inner surface of the core comprises a step part corresponding to each width of the second main body and the first main body.

10. The coil device according to claim 1, wherein an insulation layer is formed on a surface of the first main body.
